(19) United States
(12) Patent Application Publication
(10) Pub. No.: US 2004/0113941 A1
(43) Pub. Date: Jun. 17, 2004

(54) User interface customization

(75) Inventors: Philip J. Sliwa, Webster, NY (US); James C. Howell, Rochester, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/318,784

(22) Filed: Dec. 12, 2002

(51) Int. Cl. G09G 5/00

(52) U.S. Cl. 345/744

(57) ABSTRACT

A way to allow customization of attributes seen in a marking machine user interface (UI) and their layout. A user can create multiple “UI sets,” each of which can include tabs, each of which can include UI elements laid out in various ways. The user can name the UI sets and tabs and can select any attribute from a superset of supported attributes, allowing custom configurations that will work across multiple printer types. Only attributes supported by a currently connected printer will show on the user's UI, so the user does not see invalid options. UI sets are stored in a file on the user's local disk, so it persists across multiple sessions and could be created by a system administrator and deployed to all the users.

### CROSS-REFERENCE TO RELATED APPLICATIONS

This application is related to U.S. patent application Ser. No. 09/871,877, filed Jun. 4, 2001 by Bunker, et al., entitled SECURE DATA FILE ERASURE (Attorney Docket No. D/A0A32).

### FIELD OF THE INVENTION

The invention relates to user interface personalization and/or customization. Embodiments particularly relate to such manipulation of marking machine and multifunction machine user interfaces.

### BACKGROUND AND SUMMARY

Through the use of the dynamic generation of user interface content and layout, the user was shown only what was relevant due to his specific networked printing environment. There was no way for the user to change the way that information was shown. Since the PSG feature set is large and complex, some customers requested a specific UI catered to the features they used most. Developing a specific UI for individual customers is not a cost-effective challenge. The solution implemented allows the user to control what features are seen on the UI. This solution allows the user to build the custom UI, instead of Xerox building a different solution for each customer.

Through the use of custom UIs, users have a way to control what features are shown and how they are displayed. A user could develop many different custom UIs, either for use on specific printers, for specific jobs, or simply to shorten UI response time and view only what was necessary. The user could spend much time creating and customizing these UIs, but there was no way to share them with other users. Other users would have to go through the same amount of work the first user did, to get the same results.

Also, a system administrator may want certain users to only specify certain attributes and had no way to set this up for these users except by going to each client workstation and modifying the custom UIs.

This invention is a way to allow the user to customize what attributes are seen in the user interface and how they are grouped. It allows the creation of multiple “UIs,” each of which can consist of any number of tabs, each of which can contain any number of attributes laid out in one of three ways. The “UIs” and the tabs can be named however the user desires. The user is allowed to select any attribute from the superset of supported attributes, allowing custom configurations to be made that will work across multiple printer types. Only the attributes supported by the currently connected printer will show on the user's UI, so the user does not see invalid options. This information is stored in a file on the user's local disk so it is persistent across multiple sessions and could be created by a system administrator and deployed to all the users.

This invention is a way for the custom user interface invention to be extended for administration and sharing. It provides a way for one person to utilize the custom UIs they already created and export any or all of them to a file (located wherever the user specifies) for sharing with other users. The other user receives this file and puts it in any location and can then import it through the custom UI. It will import all UIs the original user exported and merge them with the current user's existing custom UIs. If an existing UI and imported UI have the same name, the user can choose which one to keep.

### BRIEF DESCRIPTION OF THE DRAWINGS

FIG. 1 is a schematic illustration of a UI set configurator according to embodiments.

FIG. 2 is a schematic illustration of a feature of a UI set configurator according to embodiments.

FIG. 3 is a schematic illustration of a UI set collection and selection interface according to embodiments.

FIG. 4 is a schematic illustration of a UI export interface according to embodiments.

FIG. 5 is a schematic illustration of an additional feature of the UI export interface of FIG. 4 according to embodiments.

FIG. 6 is a schematic illustration of a UI import interface according to embodiments.

FIG. 7 is a schematic illustration of an alert feature of the UI import interface of FIG. 6 according to embodiments.

### DESCRIPTION

For a general understanding of the present invention, reference is made to the drawings. In the drawings, like reference numerals have been used throughout to designate identical elements.

Embodiments include a set of user interface elements that can be selected by a user. The set can, in embodiments, be saved for future use by the user and by other users. Additionally, embodiments allow importation and exportation of user interface (UI) sets, allowing sharing of UI sets with users of other machines. In embodiments in which a common set language is employed, other UI customization applications can read the UI sets, and embodiments can import UI sets from other UI customization applications. In embodiments, the UI sets can be exported into various formats, including formats that other UI customization applications can understand.

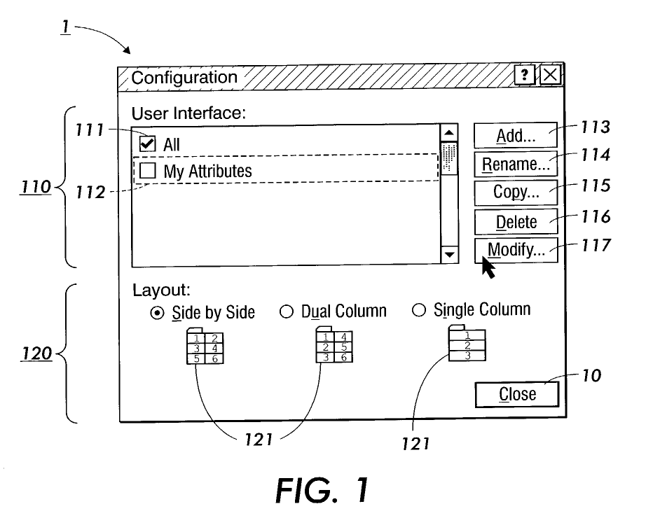

A UI configurator 1 according to embodiments is shown schematically in FIG. 1. The configurator includes a UI set listing and selection area 110 in which one or more preset UI sets 111 can be listed, as well as any user-created sets 112. In embodiments, a default UI set 111 can include all features and can not be edited or deleted. This ensures that a baseline UI set is always available for user support. The UI listing and selection area 110 can also include UI elements 113-117 that allow addition, renaming, copying, deletion, and/or modification of UI sets. The configurator 1 can also include, in embodiments, a layout area 120 in which a layout 121 of UI elements can be selection. A “Close” element 10 can also be included to allow dismissal of the configurator.

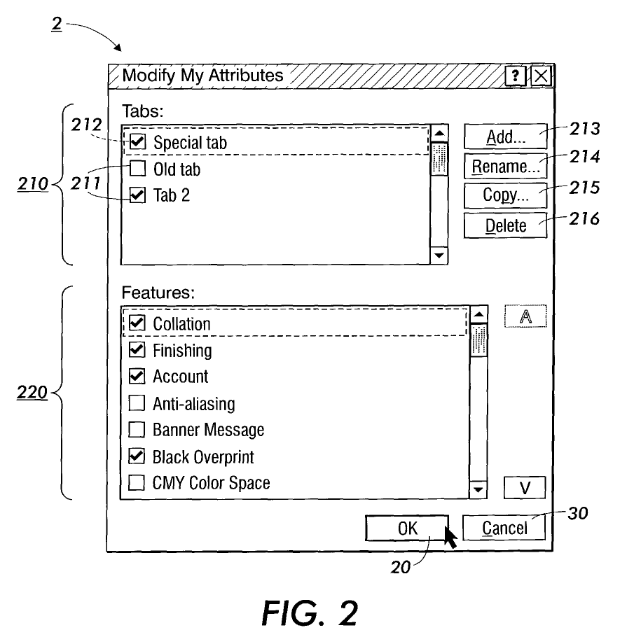

As shown in FIG. 2, a set modifier 2 according to embodiments can include a “tab” listing area 210 and a feature listing area 220. The tab listing area 210 can display tabs 211 to be included in a UI set 111, 112. Additionally, the tab listing area can include UI elements 213-216 to allow addition, renaming, copying, and/or deletion of tabs. The feature listing area 220 shows features 221 that are and/or can be included on a tab 211. The modifier 2 can also include UI elements 20, 30 for accepting and canceling changes, respectively.

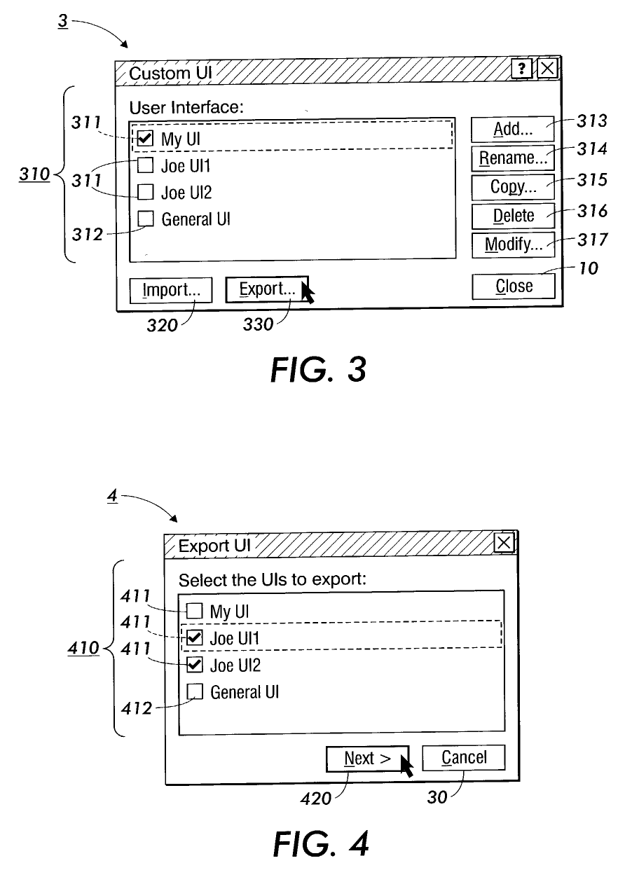

An alternate UI configurator 3 is shown schematically in FIG. 3 and includes a UI set listing area 210, an “Import” UI element 320, and an “Export” UI element 330. Like the configurator 1 of FIG. 1, the alternate configurator 3 includes UI elements 313-317 that allow addition, renaming, copying, deletion, and/or modification of UI sets 311, 312. The configurator 3 can also include, in embodiments, a layout area such as the layout area 120 of the configurator 1 shown in FIG. 1. A “Close” element 10 can also be included to allow dismissal of the configurator.

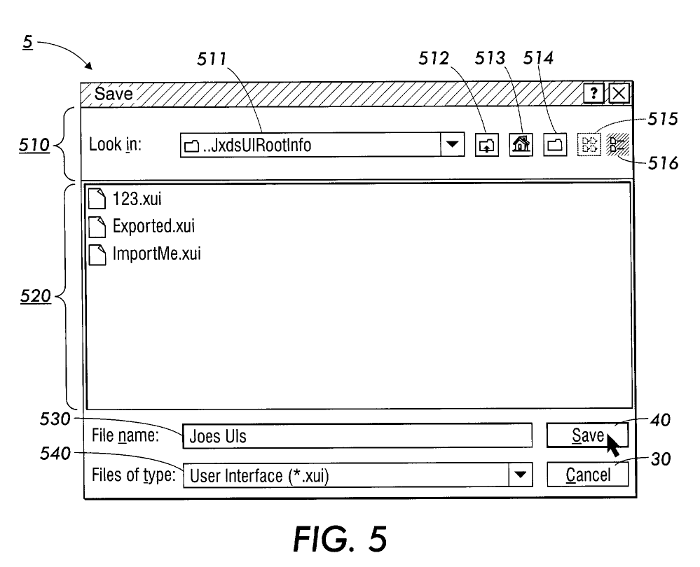

The “Export” UI element 330 can be used to save a file including a selected UI set 311, 312 to a desired location. Invoking the “Export” UI element 330 will result in, for example, an export dialog box 4, such as that shown schematically in FIG. 4. Such an export dialog box 4 can include a UI set listing area 410 in which UI sets 411, 412 can be displayed and selected. Additionally, the export dialog box 4 can include a cancel UI element 30 and a “Next” UI element 420. Invoking the “Next” UI element 420 can call a “Save” dialog box 5, such as that shown schematically in FIG. 5.

The “Save” dialog box 5 can be a standard GUI “Save” dialog box, for the most part, as found in most GUI computer operating systems. For example, the dialog box 5 can include a navigational tool bar 510, a contents listing area 520, a file name field 530, a file type selection tool 540, and additional UI elements, such as a “Save” element 40 and a “Cancel” element 30. The tool bar 510 can include, for example, a folder/directory selection menu 511, an “up one level” button 512, a “home” button 513, a “new folder” button 514, and display option buttons 515, 516. The contents listing area 520 can display the contents of the folder/directory selected in the menu 511 and can include files and folders/directories. The contents can be displayed in accordance with the display option buttons 515, 516 and the file type tool 540. When a user has navigated to a desired location, the user can save the UI set selected in the “Export” dialog box 4 with a desired name specified in the name field 530 by invoking the “Save” UI element 40. If the user decides not to export the UI set after all, the user can invoke the “Cancel” UI element 30.

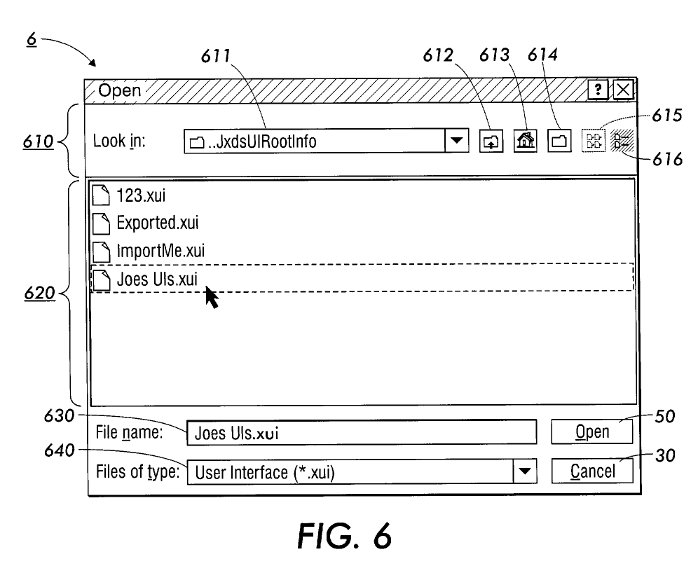

In embodiments, invoking the “Import” UI element 320 can call an “Open” dialog box or the like 6, such as that shown in FIG. 6. An “Open” dialog box 6, like the “Save” dialog box 5, can be a standard GUI “Open” dialog box as found in most GUI computer operating systems. For example, the dialog box 6 can include a navigational tool bar 610, a contents listing area 620, a file name field 630, a file type selection tool 640, and additional UI elements, such as an “Open” element 50 and a “Cancel” element 30. The tool bar 610 can include, for example, a folder/directory selection menu 611, an “up one level” button 612, a “home” button 613, a “new folder” button 614, and display option buttons 615, 616. The contents listing area 620 can display the contents of the folder/directory selected in the menu 611 and can include files and folders/directories. The contents can be displayed in accordance with the display option buttons 615, 616 and the file type tool 640. When a user has navigated to a desired location, the user can open a desired UI set selected in the contents listing area 620 and/or with a desired name specified in the name field 630 by invoking the “Open” UI element 50. If the user decides not to import the UI set after all, the user can invoke the “Cancel” UI element 30.

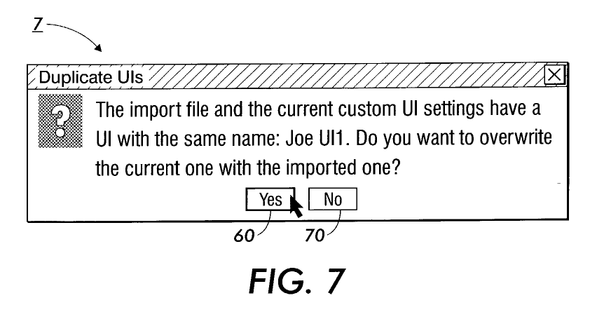

As seen in FIG. 7, if a user tries to open or save a UI set with a name that already exists, a warning dialog box 7 can be displayed. The warning dialog box 7 can include “Yes” and “No” UI elements 60, 70 or the like to confirm and/or reject overwriting of the existing UI set.

Thus, in embodiments, the user can customize content and layout of the UI. For example, one or more actions can be employed, such as:

Adding a new UI set and naming it

Adding new tabs to the UI set and naming them

Selecting attributes, from all available attributes, to add to each tab and in which order

Selecting which layout scheme to apply to the UI, such as side-by-side, dual column, and single column, which can control how the selected attributes will be laid out on each tab of the UI

The user can thus create UI sets and tabs in embodiments, and can choose to not display them at any time without losing the information contained within them. There are also, in embodiments, simple ways to rename, copy and delete any existing UI sets or tabs.

The baseline set of UI features 221 can be the superset of most of the features supported by a particular UI. Advantageously, features such as special pages features (covers, page inserts, exception pages, chapter starts), PDL Type, and the print/save options are not included in the superset 221. If a user creates custom UIs with one release of a UI, and the next release of the UI supports new features, embodiments ensure that the user's customizations will stay intact and the user will see the updated features at the bottom of the Features list 221 for existing tabs (so as to not interfere with any feature ordering the user already had in place). On any newly created tabs, the features can be integrated with the previously existing features in the alphabetical list. If for some reason a feature is removed from one release to the next, that feature can automatically be removed from any existing tabs.

When the system supports login ability, different functions can be displayed for an administrator versus for a general user, such as restricting access to UI set creation or deletion or restricting access to customizing the UI at all. Administrators can “hide” the default UI and supply their own default UI through the installation procedure. In embodiments, PDL type Print/Save options and/or a Special Pages tab can be added to a custom UI sets, making it less necessary to use a manufacturer-distributed UI. Additionally, embodiments provide a way to restrict which options are available on the Special Pages tab.

Thus, to recapitulate, embodiments provide a customizable user interface comprising at least one UI element and a configurator. The interface can be used, for example, as a user interface of a marking machine. Alternatively, the interface can be implemented as a user interface of marking machine driver software.

The configurator can an element designator with which a user can selectively designate UI elements as being part of a custom UI set. One or more custom user interface set including at least one pre-designated combination of user interface UI elements can be included to provide a baseline UI set from which a user can start. For example, one of the included baseline UI sets can have all available elements designated, and/or one of the UI sets can have only core elements designated. In embodiments, a user can alter at least a portion of a custom UI set.

In embodiments, the configurator further comprises a layout tool with which a user can selectively assign a layout of a custom UI set. The layout tool can include, for example, an option to present elements side by side, and/or the layout tool can include an option to present elements in at least one column. In more comprehensive embodiments, the user can specify a position of each designated element.

A software application can include the element designator and the element layout tool, the software application being usable to configure a UI of a marking machine. The UI of a marking machine being configured can reside on the marking machine or can be a driver of the marking machine that resides on a device other than the marking machine. The software application of embodiments can manipulates preference or set files of the UI. Designating a custom UI set can include selecting a predetermined set, disabling designating one or more UI element as part of the set, and indicating that a new set will be created, as by a “Save As . . . ,” “Export,” or “Duplicate” command. A UI data file can be manipulated to present the at least one UI element designated by the user in the position specified. In embodiments, the custom interface set can be stored in a UI data file or can be stored in a preference file separate from the UI data file.

Embodiments can be deployed, for example, in a graphical user interface (GUI) dialog box. The Import and Export buttons are available in the custom UI window for easy access. In Export, the user can select which of the existing UIs he wishes to export. The exported user interface can be stored anywhere and can have an identifying label, such as a “xui” extension. The location in which the user saves the set will be saved so the next time he or she wishes to export, the export function will default to the last location accessed. To import, a user browses to and selects the desired user interface set. In embodiments, the directory from which the user loads the set will be saved so the next time he or she wishes to import, the import function will default to the last location accessed. If the user already had a custom UI with the same name as one to import, the user can choose which to keep.

Beyond the sharing of custom UIs, importing and exporting provides a “system administrator” a way to manage all users' UIs. The administrator can create any number of custom UIs for different purposes and choose which ones to export to certain individuals. He could even name them however he wishes, such as “Team UI” or “Special users UIs” or “Joe's UIs.”

This can be extended when a security model is in place so that only certain users could create or modify custom UIs but all could import them. In this scenario, an administrator could control what attributes each user could specify by providing each with an exported custom UI file. Also, this can include viewing of certain “Xerox provided” pathways, such as Job Settings and Administration. The system administrator can say if a user should be able to view either of these pathways or just the ones he creates for the users. This allows even more security in that certain users wouldn't be able to see other users' jobs or ever send certain attributes on a job.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A customizable user interface comprising:
at least one user interface element; and
a configurator including an element designator with which a user can selectively designate the at least one user interface element as being part of a custom user interface set.

2. The interface of claim 1 further comprising at least one custom user interface set including at least one pre-designated combination of user interface elements.

3. The interface of claim 2 wherein a user can alter at least a portion of at least one of the at least one custom user interface set.

4. The interface of claim 2 further comprising a custom user interface set in which all available elements are designated.

5. The interface of claim 2 further comprising a custom user interface set in which core elements are designated.

6. The interface of claim 1 implemented as a user interface of a marking machine.

7. The interface of claim 1 implemented as a user interface of marking machine driver software.

8. The interface of claim 1 wherein the configurator further comprises a layout tool with which a user can selectively assign a layout of the custom user interface set.

9. The interface of claim 8 wherein the layout tool includes an option to present elements side by side.

10. The interface of claim 8 wherein the layout tool includes an option to present elements in at least one column.

11. The interface of claim 8 wherein the user can specify a position of each designated element.

12. A user interface customization tool comprising:
an element designator with which a user designates at least one user interface element as part of a custom interface set; and
an element layout tool with which a user specifies a position of the at least one user interface element.

13. The tool of claim 12 further comprising a software application including the element designator and the element layout tool, the software application usable to configure a user interface of a marking machine.

14. The tool of claim 13 wherein the user interface of a marking machine resides on the marking machine.

15. The tool of claim 13 wherein the user interface of a marking machine is a driver of the marking machine that resides on a device other than the marking machine.

16. The tool of claim 12 wherein the element designator includes at least one custom user interface set in which respective sets of designated elements are stored.

17. The tool of claim 16 wherein the at least one custom user interface set includes a core set of designated interface elements.

18. The tool of claim 16 wherein the at least one custom user interface set includes a set of all available designated interface elements.

19. The tool of claim 12 wherein the layout tool includes at least one layout preset available for user selection.

20. The tool of claim 12 wherein the at least one layout preset includes a layout preset in which user interface elements are presented side by side.

21. The tool of claim 12 wherein the at least one layout preset includes a layout preset in which user interface elements are presented in at least one column.

22. A user interface customization method comprising:
providing a customization tool;
designating at least one custom user interface set;
designating at least one user interface element as part of the at least one custom user interface set; and
specifying a position of the at least one user interface element.

23. The method of claim 22 wherein providing a customization tool comprises providing a software application that manipulates preference files of the user interface.

24. The method of claim 22 wherein designating at least one custom user interface set includes selecting a predetermined set.

25. The method of claim 24 further comprising disabling designating at least one user interface element as part of the set.

26. The method of claim 22 wherein designating at least one custom user interface set includes indicating that a new set will be created.

27. The method of claim 22 further comprising manipulating a user interface data file to present the at least one user interface element designated by the user in the position specified.

28. The method of claim 27 wherein the at least on custom interface set is stored in the user interface data file.

29. The method of claim 27 wherein the at least one custom interface set is stored in a preference file separate from the user interface data file.
